(19) United States
(12) Patent Application Publication
(10) Pub. No.: US 2014/0288980 A1
(43) Pub. Date: Sep. 25, 2014

(54) MOBILE SOLUTION FOR VENUES AND TEAMS TO INCREASE THEIR SEAT REVENUE

(71) Applicant: MASCOTSECRET LLC, Cleveland, OH (US)

(72) Inventors: Yen-Yao Lee, Cleveland, OH (US); Jennifer Jeng, Cleveland, OH (US)

(73) Assignee: MASCOTSECRET LLC, Cleveland, OH (US)

(21) Appl. No.: 14/091,216

(22) Filed: Nov. 26, 2013

Related U.S. Application Data
(60) Provisional application No. 61/730,299, filed on Nov. 27, 2012.

(51) Int. Cl. G06Q 10/02

(52) U.S. Cl. CPC G06Q 10/02
USPC 705/5

(57) ABSTRACT

The field of the invention relates to systems and methods for selling seat upgrade capabilities, upgrading fan experience capabilities, connecting fan engagement activities provided by venues with the fans capabilities, and other services in an event or venue using an application or mobile browser. In an embodiment, during an event, a mobile upgrade and fan engagement system receives login information from a mobile device, retrieves account information based on the login information, receives information of a first purchased ticket, receives one or more upgrade selections from the mobile device, determines availability of one or more upgrades, displays the availability of one or more upgrades at the mobile device, receives one or more upgrade purchases based on availability, from the mobile device, completes payment for the one or more upgrade purchases, displays one or more upgrade electronic tickets at the mobile device, and releases the first purchased ticket for sale.

### CROSS-REFERENCE TO RELATED APPLICATIONS

The present application claims priority to U.S. Provisional Application No. 61/730,299 filed Nov. 27, 2012, which is hereby incorporated by reference in its entirety.

### FIELD OF THE INVENTION

The field of the invention relates to systems and methods for selling seat upgrade capabilities, and more particularly to selling seat upgrade capabilities, upgrading fan experience capabilities, connecting fan engagement activities provided by venues with the fan capabilities, and other services in an event or venue using an application and/or mobile browser.

### BACKGROUND OF THE INVENTION

Currently, when a participant in an event, for example, a sports or entertainment event, has purchased and then attends the event, the participant generally cannot change the purchased seat once the participant has been seated. Otherwise, the participant may have to return to the ticket window, wait in line, inquire for a better seat, and request for an exchange or upgrade. Certain online applications may allow the participant to purchase new seats, but not to exchange or upgrades after the participant has already checked in at the venue.

A participant may also want to purchase additional service interactively or in real-time. For example, at a sports event, a fan may want to be on the stadium screen (e.g., a Jumbotron screen). Currently, the fan can only act or dress in a certain way to catch the attention of the camera operators. There is currently no real-time service or interaction with the event organizers and the fans during the event to offer the fan, for example, a chance to be on the stadium screen, in the “high-five tunnel”, or have a visit with the mascot. These services are generally limited to corporate, special group or very important individual “VIP” tickets holders. There may also be other services that the event organizers may interactively and in real-time offer to the fans.

In view of the above limitations, and with the advance and widespread use of mobile devices, there is a need for systems and methods for providing efficient and accessible services for venues and teams to increase their seat and fan engagement experiences revenue.

### SUMMARY OF THE INVENTION

The field of the invention relates to systems and methods for selling seat upgrade capabilities and other services in an event or venue using an application or mobile browser.

In an embodiment, a mobile upgrade and fan engagement system having one or more processors and a non-transitory computer-readable medium containing program instructions that cause said one or more processors, during an event, to receive login information from a mobile device, retrieve account information based on the login information, receive information of a first purchased ticket, receive one or more upgrade selections from the mobile device, determine availability of one or more upgrades, display the availability of one or more upgrades at the mobile device, receive one or more upgrade purchases based on availability, from the mobile device, complete payment for the one or more upgrade purchases, display one or more upgrade electronic tickets at the mobile device, and release the first purchased ticket for sale. It is noted that the above steps are not required to be performed in any particular order.

In another embodiment, a mobile upgrade and fan engagement system having one or more processors and a non-transitory computer-readable medium containing program instructions that cause said one or more processors, during an event, to receive login information from a mobile device, retrieve account information based on the login information, receive one or more fan engagement selections from the mobile device, determine availability of one or more fan engagements, display the availability of one or more fan engagements at the mobile device, receive one or more fan engagement purchases based on availability, from the mobile device, complete payment for the one or more fan engagement purchases, and display one or more fan engagement receipts at the mobile device. It is noted that the above steps are not required to be performed in any particular order.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features, and advantages here provided will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1A is an exemplary diagram of a mobile upgrade and fan engagement system according to an embodiment of the present invention.

FIG. 1B is an exemplary block diagram of a mobile upgrade and fan engagement server according to an embodiment of the present invention.

FIG. 1C another exemplary block diagram of a mobile upgrade and fan engagement server according to an embodiment of the present invention.

FIG. 1D is another exemplary diagram of a mobile upgrade and fan engagement system according to an embodiment of the present invention.

FIG. 1E is another exemplary diagram of a mobile upgrade and fan engagement system according to an embodiment of the present invention.

FIG. 1F is an exemplary use case diagram of a mobile upgrade and fan engagement system according to an embodiment of the present invention.

FIGS. 2A and 2B are exemplary flow diagrams of a mobile upgrade and fan engagement system according to an embodiment of the present invention.

FIG. 3 is an exemplary interface according to an embodiment of the present invention, showing a main page.

FIG. 4 is an exemplary interface according to an embodiment of the present invention, showing a sign up page.

FIG. 5A is an exemplary interface according to an embodiment of the present invention, showing a “forget” password page.

FIG. 5B is another exemplary interface according to an embodiment of the present invention, showing a “forget” password page.

FIG. 6 is an exemplary interface according to an embodiment of the present invention, showing an “enter new” password page.

FIG. 7 is an exemplary interface according to an embodiment of the present invention, showing a venue search screen.

FIG. 8 is an exemplary interface according to an embodiment of the present invention, showing a venue search screen pop up notification.

FIG. 9A is an exemplary interface according to an embodiment of the present invention, showing an events list screen.

FIG. 9B is another exemplary interface according to an embodiment of the present invention, showing an events list screen.

FIG. 10 is an exemplary interface according to an embodiment of the present invention, showing a scan ticket screen.

FIG. 11 is an exemplary interface according to an embodiment of the present invention, showing an enter ticket barcode screen.

FIGS. 12A and 12B are exemplary interfaces according to an embodiment of the present invention, showing enter number of seats, row, or selection screens.

FIGS. 13A and 13B are exemplary interfaces according to an embodiment of the present invention, showing seats not available screens.

FIGS. 14A, 14B and 14C are exemplary interfaces according to an embodiment of the present invention, showing available seating screens.

FIG. 15 is an exemplary interface according to an embodiment of the present invention, showing a payment details screen.

FIG. 16 is another exemplary interface according to an embodiment of the present invention, showing a payment details screen.

FIGS. 17A, 17B, 18A and 18B are exemplary interfaces according to an embodiment of the present invention, showing electronic ticket screens.

FIG. 18C is an exemplary code according to an embodiment of the present invention, showing a ticking clock code.

FIG. 19 is another exemplary interface according to an embodiment of the present invention.

FIG. 20 is another exemplary XML code according to an embodiment of the present invention, showing a third party request response.

FIG. 21 is an exemplary diagram according to an embodiment of the present invention, showing entity relationships.

FIG. 22 is another exemplary interface according to an embodiment of the present invention, showing a main page.

FIG. 23 is another exemplary interface according to an embodiment of the present invention, showing a fan engagement page.

FIGS. 24, 24A, 24B and 24C are other exemplary interfaces according to an embodiment of the present invention, showing fan engagement pages.

FIG. 25 is an exemplary interface according to an embodiment of the present invention, showing a fan engagement confirmation page.

FIG. 26 is an exemplary interface according to an embodiment of the present invention, showing a fan engagement receipt page.

### DETAILED DESCRIPTION OF THE PREFERRED EMBODIMENTS

Although described with particular reference to certain industries and/or equipment, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

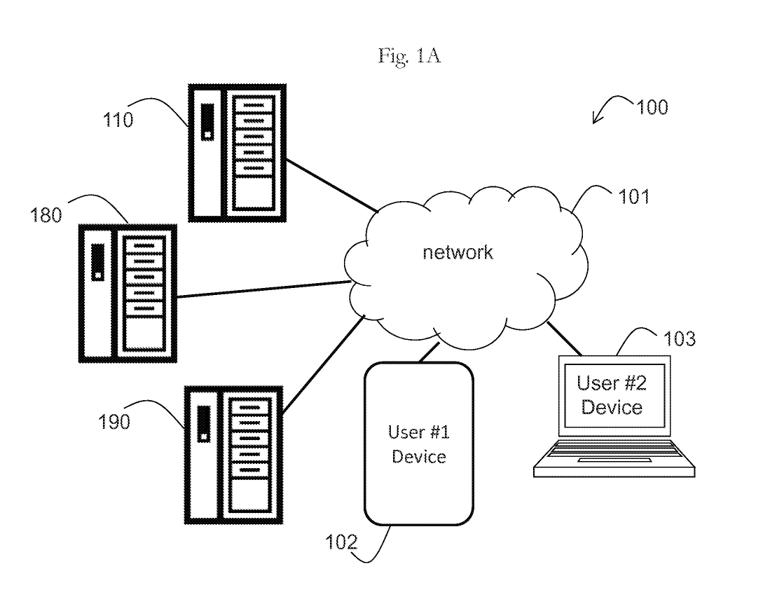

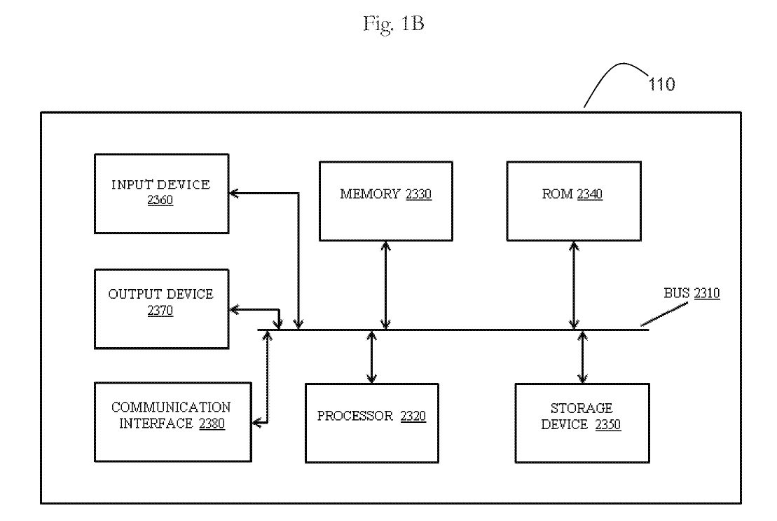

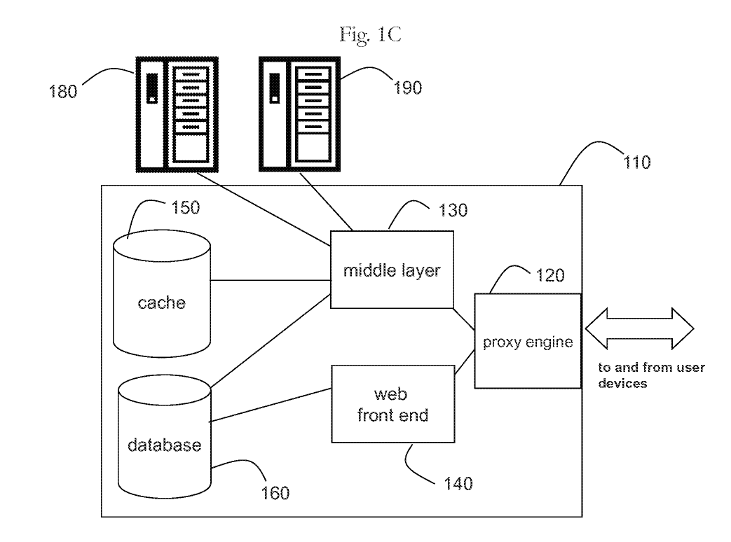

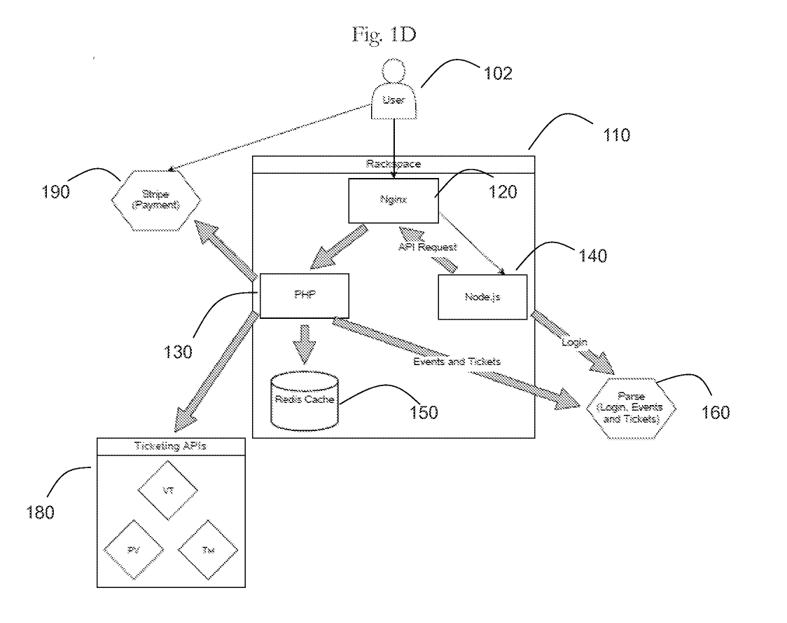

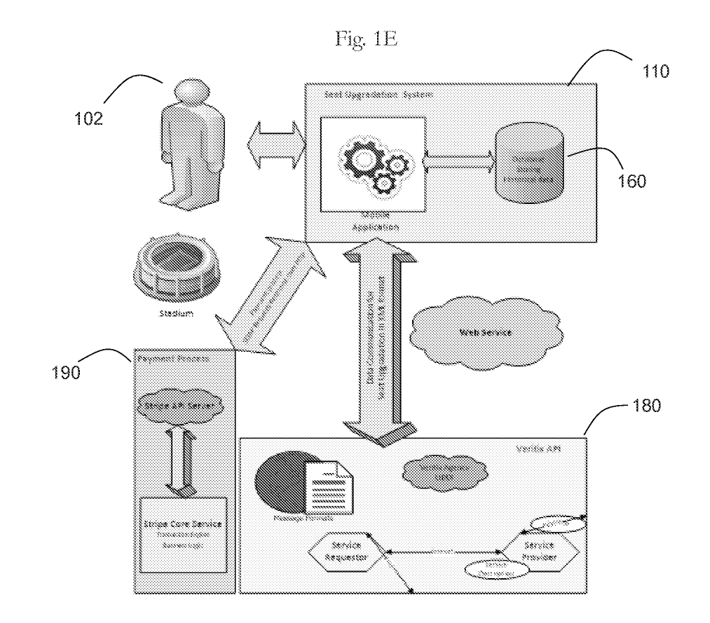

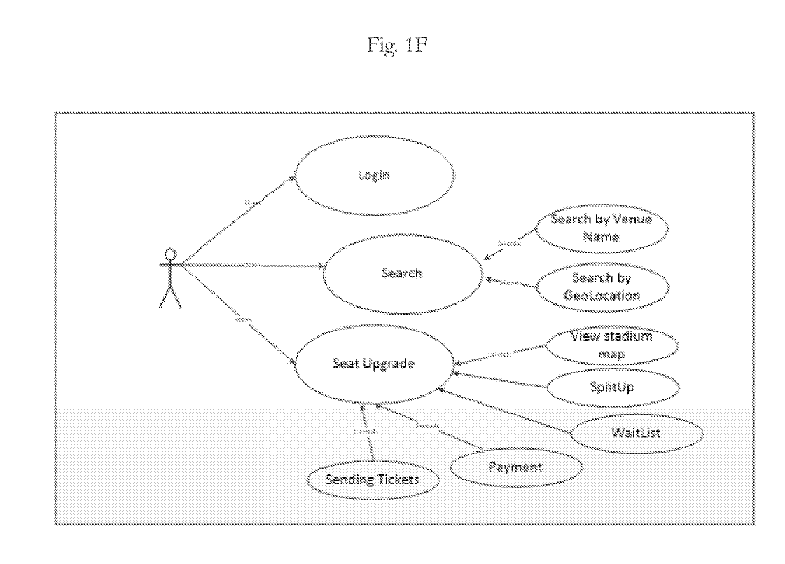

Turning to FIG. 1A, an exemplary diagram of the mobile upgrade and fan engagement system 100 architecture is shown. In an embodiment, the system 100 generally provides a mobile web-based application (“web app”) which is friendly and/or compatible with all new mobile computing devices based on mobile operating systems, e.g. iOS, Android, Blackberry, Windows platforms, and so on. The mobile web app is an Internet-based application that may be accessed through a web browser on the user device. In another embodiment, the system 100 may provide an application, e.g. a native iOS application, a native Android application, and so on. A native application is installed in the user device.

In an embodiment, the system 100 may provide seat upgrade capabilities in an event (e.g., NBA, MLB, NFL, games, concerts, and so on). An exemplary product with these capabilities is MascotSecret (at http://mascotsecret.com/). In another embodiment, the system 100 may provide upgrades in both the primary and secondary markets.

In an embodiment, the system 100 generally includes a host server 110, which may be distributed on one or more physical servers, each having processor, memory, an operating system, and input/output interface, and a network interface all known in the art, a plurality of end user computing devices 102,103 coupled to a network 101, such as the Internet, a cellular-based wireless network, or private network; a ticketing system 180; and a payment system 190.

Turning to FIG. 1B, an exemplary architecture for implementing a server 110 according to an embodiment is shown. It will be appreciated that other devices that can be used with the server 110, such as a client or a server, may be similarly configured. As illustrated in FIG. 1B, server 110 may include a bus 2310, one or more processors 2320, a memory 2330, a read only memory (ROM) 2340, a storage device 2350, an input device 2360, an output device 2370, and a communication interface 2380 all known in the art.

Bus 2310 may include one or more interconnects that permit communication among the components of the server 110. Processor 2320 may include any type of processor, microprocessor, or processing logic that may interpret and execute instructions (e.g., a field programmable gate array (FPGA)). Processor 2320 may include a single device (e.g., a single core) and/or a group of devices (e.g., multi-core). Memory 2330, such as cache 150 (FIG. 1C), may include a random access memory (RAM) or another type of dynamic storage device that may store information and instructions for execution by processor 2320. Memory 2330 may also be used to store temporary variables or other intermediate information during execution of instructions by processor 2320.

ROM 2340 may include a ROM device and/or another type of static storage device that may store static information and instructions for processor 2320. Storage device 2350 may include a magnetic disk and/or optical disk and its corresponding drive for storing information and/or instructions. Storage device 2350 may include a single storage device or multiple storage devices, such as multiple storage devices operating in parallel. Moreover, storage device 2350 may reside locally on the computing device 2300 and/or may be remote with respect to a server and connected thereto via network and/or another type of connection, such as a dedicated link or channel. Storage device 2350 may reside in a cloud network, for example, in Infrastructure-as-a-Service (IaaS).

Input device 2360 may include any mechanism or combination of mechanisms that permit an operator to input information to computing device 2300, such as a keyboard, a mouse, a touch sensitive display device, a microphone, a pen-based pointing device, and/or a biometric input device, such as a voice recognition device and/or a finger print scanning device. Output device 2370 may include any mechanism or combination of mechanisms that outputs information to the operator, including a display, a printer, a speaker, etc.

Communication interface 2380 may include any transceiver-like mechanism that enables computing device 2300 to communicate with other devices and/or systems, such as a client, a server, a license manager, a vendor, etc. For example, communication interface 2380 may include one or more interfaces, such as a first interface coupled to a network and/or a second interface coupled to a license manager. Alternatively, communication interface 2380 may include other mechanisms (e.g., a wireless interface) for communicating via a network, such as a wireless network. In one implementation, communication interface 2380 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

The server 110 may perform certain functions in response to processor 2320 executing software instructions contained in a computer-readable medium, such as memory 2330. In alternative embodiments, hardwired circuitry may be used in place of or in combination with software instructions to implement features consistent with principles of the invention. Thus, implementations consistent with principles of the invention are not limited to any specific combination of hardware circuitry and software.

The server 110 and computing devices discussed herein may include any type of device, including telephone, fax machine, mobile telephone, laptop, tablet, desktop computer, netbook, video game device, pager, smart phone, ultra-mobile personal computer (UMPC), or personal data assistant (PDA), and so on. Devices may run one or more applications, such as Internet browsers, voice calls, video games, videoconferencing, and email, among others. Devices may be any combination of devices. These devices may be coupled to a network.

A server may also be any type of computing device including but not limited to a personal computer, a server computer, a series of server computers, a mini computer, and a mainframe computer, or combinations thereof. The server may operate as a web server (or a series of servers) running a network operating system, examples of which may include but are not limited to Microsoft Windows Server, Novell NetWare, or Linux. Any of the features of the server may be also implemented in one or more additional servers. A server may reside in a cloud network, for example, in Infrastructure-as-a-Service (IaaS).

A server may include one or more modules. The one or more modules may be configured to send, process, and receive information at server. One or more modules may send and receive information using any technique for sending and receiving information between processes or devices including using a scripting language, a remote procedure call, an email, a tweet, an application programming interface, Simple Object Access Protocol (SOAP) methods, WCF, Common Object Request Broker Architecture (CORBA), any interface for software components to communicate with each other, using any other known technique for sending information from a one device to another, or any combination thereof. One or more modules may implement all or portions of the exemplary discussed herein.

A server may include database, such as database 160 (FIG. 1C). A database may be any type of database, including databases managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, and PostgreSQL, Parse etc. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

A network, such as network 101, may provide network access, data transport and other services to the devices coupled to it. In general, a network may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, a network may implement one or more of a GSM architecture, a General Packet Radio Service (GPRS) architecture, a Universal Mobile Telecommunications System (UMTS) architecture, and an evolution of UMTS referred to as Long Term Evolution (LTE). A network may, again as an alternative or in conjunction with one or more of the above, implement a WiMAX architecture defined by the WiMAX forum. A network may also comprise, for instance, a local area network (LAN), a wide area network (WAN), the Internet, a virtual LAN (ULAN), an enterprise LAN, a layer 3 virtual private network (VPN), an enterprise IP network, a cellular network, a telecommunications network, a broadcast network, a radio broadcast network, a television broadcast network, a social network, or any combination thereof.

A website may include any type of website or web page. For example, one or more websites may be coded using hypertext markup language (“HTML”), XML, XHTML, JavaScript, Java, Perl, Visual Basic, Hypertext Preprocessor scripts (“PHP”), Active Server Page scripts (“ASP”), Objective-C, common gate interface (“CGI”) scripts, server side includes, and combinations thereof. One or more websites may include the exemplary interfaces depicted by the figures.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Turning to FIG. 1C, an exemplary diagram of the host server 110 is shown. Generally, a host server 110 may include a proxy engine 120 which provides proxy services and routes requests between a web user and the application layers; a web front end 140 which connects to a middle layer 130 (e.g., with JSON calls), a database 160 (e.g., Parse database) for user authentication, and a cache server 150 (e.g., Redis cache server) for session storage.

In an embodiment, the system 100 is an upgrade platform that allows fans to upgrade their tickets using their mobile device 102 during the game. It is built on the latest mobile web, Android and iOS platforms with a secure, stable and robust technical stack. The application layers connect the web front end 140 Android and iOS interfaces with the middle layer 130 and database 160 to third-party backend ticketing systems 180. The system 100 also integrates with several technology platforms including Strip, Parse and Twillio, to provide an industry leading solution.

Turning to FIG. 1D, according to an embodiment, the server 110 may be hosted with Rack Space or Amazon Web Services (AWS), or with other cloud hosting companies. Server instances may be deployed in one or more geographic regions. As described above, any of the features of the server may be also implemented in one or more additional servers. A server may also reside in a cloud network, for example, in Infrastructure-as-a-Service (IaaS). Rackspace data centers are PCI-DSS and Safe Harbor compliant in addition to having SSAE16 Type II, SOC1, SOC2 (Security and Availability Only), and SOC3 audits on file for all data center facilities. AWS utilizes Trend Micro products Deep Security, which includes intrusion detection and prevention, firewall, anti-malware, web reputation and integrity monitoring; and SecureCloud, such as disk encryption integrated with Deep Security. The server 110 may also use Nginx for proxy engine 120, for proxy services and routing requests between the web user and the application layers.

In an embodiment, the web front end 140 may be written in Node.js and built using the Express framework with Jade templates. Express is a lightweight web application framework used to organize the web app into a Model-View-Controller (MVC) architecture on the server side. Jade is terse templating engine with a focus on performance that allows for the separation of application logic from interface markup code.

In an embodiment, the system 110 may include an Android and iOS front end to interface with the database 160. The iOS application may be written in Objective C, and the Android application may be written in Java, both using the Parse iOS SDK, the Stripe iOS token generator, and the system's 100 middle layer 130 API. The Parse SDK is used for user signup and login, and retrieving previously purchased tickets for the active user. The Stripe token generator is used to create a unique token to represent the user's credit card which allows the system 100 to process payment without retaining any credit card information on the system 110. All event, seating and other ticketing functions may be handled through JSON requests to the middle layer 130 API.

In an embodiment, the middle layer 130 may be written in PHP and may act as a common interface between the application itself, and the ticketing systems 180, payment system 190 and Parse backend 160. In addition, it provides a layer of security and verifies that data being distributed to the various systems is correctly formatted and complete and that any errors are handled appropriately. Requests made from the application to the middle layer 130 may be in JSON format, and requests from the middle layer 130 to the other external systems may be in JSON or XML format.

In an embodiment, the backend data is stored in a Parse instance. Parse is a secure cloud based data storage that allows for automatic performance and scaling. Parse also handles login and user authentication for the application. Parse is hosted on the AWS infrastructure and is PCI compliant.

In an embodiment, the server 110 may use Redis to increase performance by caching calls between the middle layer 130 and the ticketing system 180 APIs. Redis is a key/value store that the application uses to store event, session and ticket availability data.

In an embodiment, the middle layer 130 connects to one or more third-party ticketing companies 180 using both JSON and XML call to their APIs. The application may include ticketing interfaces to, for example, Veritix, ProVenue (Tickets.com), Ticketmaster and others. The system 100 application may be ProVenue certified. The middle layer 130 is also designed to handle its own ticket provision system for teams without a backend ticketing system 180.

In an embodiment, payment for the application is processed by the Stripe payment gateway 190. No cardholder data is processed by nor retained by the server 110. The payment from the application submits directly to Stripe and only a payment token is passed to the server 110 from Stripe. Stripe has been audited by a PCI-certified auditor, and is certified to PCI Service Provider Level 13. This is the most stringent level of certification available.

In an embodiment, for texting, the system 100 application may use the Twilio web service API to send ticket upgrades via text messaging. Twilio web service is cloud communications, Infrastructure-as-a-Service (IaaS).

In an embodiment, the upgrade system 100 may be accessed through: (1) embedded in a team's/venue's application—the user will never know they left their favorite team's application; (2) embedded via the team's, i.e. through the official NBA, NHL, etc., website; (3) stand-alone as its own native application that can be downloaded and then used across different teams and venues; or (4) stand-alone web application that can be accessed anywhere across venues and teams via the mobile browser.

The mobile native and web application may be white labeled for teams. When the application is white labeled, the team will have their personalized skins for the User Interface (UI) experience.

In an embodiment, the system's 100 backend server or its API may integrate and communicate with ticket office's box office system 180, its backend API and all other relevant resources to read any relevant data in real time.

In an embodiment, portions of the system's 100 programs or applications (native or web-based) may be implemented using various APIs, programming languages, or any combination thereof. For example, portions of the programs may use Sencha Touch 2.0, JQuery, HTML 5, CSS 3.0, SQL Express 2008 R2, one or more third party APIs, and combinations thereof. The development environment may use Sencha Touch 2.0, JQuery, HTML 5, CSS 3.0, SQL Express 2008 R2, one or more third party APIs, and combinations thereof.

In an embodiment, the system's 100 backend administrative system/panel/dashboard/console or management tool may store or use the following data. The system's 100 backend administrative system/panel/dashboard/console or management tool may store or use USER LOG-IN INFO. USER LOG-IN INFO may include, but are not limited to, 1) Email (note: system's 100 server and API may cross-reference user's email information with the ticket office and team's/venue's API or CRM for both ticketing and CRM purposes); 2) User's phone number; 3) Password (subject matter's backend administrative system/panel/dashboard/console or management tool may have the ability to send users' their password or a method to reset their password via email or text if they forget their password); 4) user's first and last name, and any combination thereof.

The software's backend administrative system/panel/dashboard/console or management tool may store or use PURCHASE HISTORY. PURCHASE HISTORY may include, but are not limited to, 1) all the information on the user's original ticket, such as user's original section and row and the barcode associated with the original ticket; 2) The Upgrade(s) they purchase (include ALL seats info in the transaction: section, row, seat for seat upgrades or any information related to fan experience upgrades); 3) Which team/venue and location they are purchasing upgrades for; 4) Price of upgrade; 5) Time of purchase (will also be separated into i.e. first half, quarter or second half of game); and any combination thereof. The system's 100 backend administrative system/panel/dashboard/console or management tool may store or use phone numbers or email as a means of communication during the “TEXTING STAGE”, which may include sending out of tickets from one user to another user. The tickets that can be text or sent out may be limited to users with an account through or connected to the system's 100 software and/or which specific tickets of user's purchase; or a combination thereof. TEXTING STAGE may include 1) Who the user sends/texts the ticket to (phone number or login info); 2) Who sends/texts tickets to user; and any combination thereof.

The system's 100 software may provide features for Box Office Resolution. Box Office Resolution options may include, but are not limited to, 1) email the box office a receipt of every upgrade purchased; 2) track the purchases on credit cards. For example, if the battery on a smartphone dies, a user may present the credit card used for purchase at the box-office and the box-office may print out a paper ticket; 3) Track all the information stored such as the upgrade purchased, original ticket etc., or 4) Tie box office resolution to the phone numbers connected with particular's smartphone; and any combination thereof.

Inventory of available seats can be obtained through multiple channels including, but not limited to, third-party communication from the team/venue/stadium's unsold or reserved inventory or from previous primary or secondary ticket purchasers who can no longer attend the event.

The previous primary or secondary purchaser may be able to push the inventory back to the team/venue/stadium to make these tickets available for upgrades during event time.

If the inventory is obtained through a previous primary or secondary purchaser, the application may associate itself with different charities. The application may allow the previously primary or secondary purchaser to pick the charity he/she wants to donate the portion of the upgrade fee as a result of selling his/her ticket to a user as an upgrade.

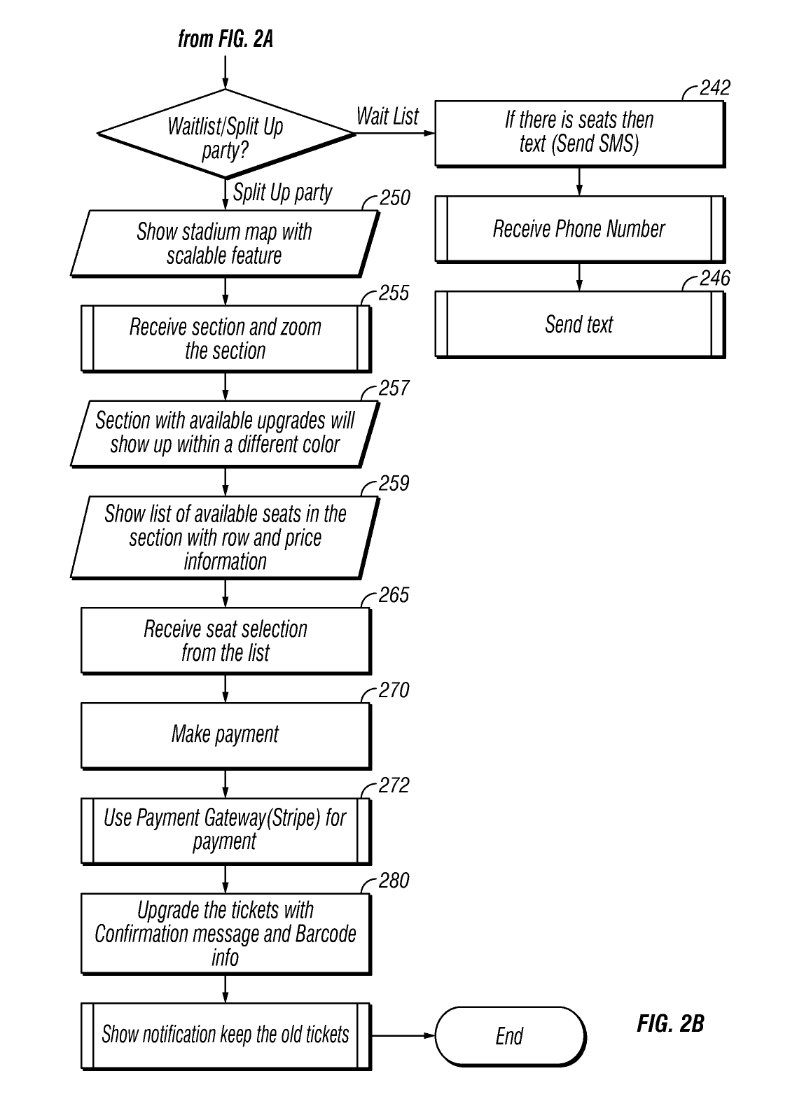

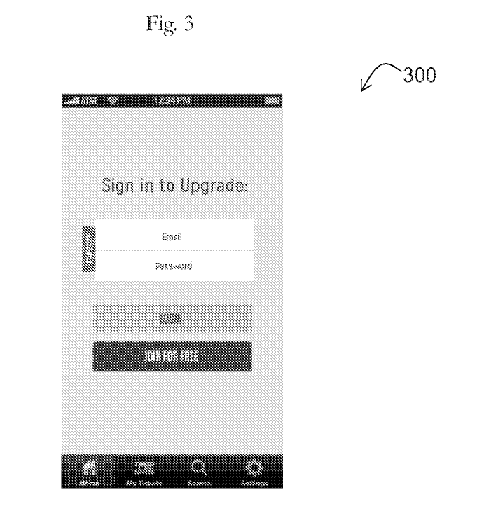

Turning to FIGS. 1E and 1F, according to one or more embodiments, exemplary architectures for implementing the server 110 are shown. FIG. 1F shows an exemplary diagram detailing the system's 100 Unified Modeling Language (UML) diagram of use case, activity and class. The use case, activity and class will be described further in the process in FIGS. 2A and 2B below.

Turning to FIGS. 2A and 2B, an exemplary process 200 for providing seat upgrade capabilities is shown. One or more embodiments may provide a mobile solution that will allow users to upgrade their seats during an event. A customer may login (Action Block 210) to the application by a simple log in monitor. If the user forgets his password, the system 100 provides the user with the ability to retrieve his password by inputting his phone number or an email, and a link to reset the password will be sent. After clicking on the link, the user can reset his password. The system 100 also provides a new user sign-up function (Action Block 212).

After login the user may then be taken to a screen (Action Block 215) where the user can search for the location he wants to upgrade for. There may be a geo-location tracker embedded in the application that may be used to determine the location (e.g., venue, stadium, or arena) of the user.

The login may include phone number, email and password. This information may be cross-referenced against the venue's or team's Client Relationship Management (“CRM”) system or data for CRM purposes, or may be referenced as a requirement for the upgrade purchase. For example, the phone number, email and password, or any combination maybe used to determine the frequency of the user, and thus, in an upgrade application, determine the price of the upgrade. Or, it may be cross referenced against the current ticketing system 180 to allow the upgrade to be processed and communicated within the team/venue/event's ticketing system.

Once the user has logged in, the system 100 provides the user the ability to upgrade (Decision Block 220). The system 100 may also display the ticket information already allocated to the user (Action Block 222). If there is no upgrade available (Decision Block 230, Action Blocks 232, 234, 242) for the selected venue/game/event the application may text the user for the wait list (Action Block 246). If upgrades are available (Decision Block 230, Action Blocks 232, 234, 242) the customer may enter the number of upgrades desired.

In one or more embodiments, the original ticket information may be collected by the software through a mobile web or native application. In the native application this information may be captured through an application using the customer's device's camera that will read and process the information on the barcode on the ticket. In the web application, users may manually input section and row or the barcode and other necessary information to determine where the user's original seats/tickets are located. In the web application, users may also take a picture of the ticket or barcode, upload the captured image(s) to system 100, which will process and interpret the barcode and existing ticket information. The processed ticket and barcode information may be returned to the end user and/or may be kept internally.

The system 100 has the ability to collect the required ticket information and push these seats back for sale or upgrade immediately after the user finalizes his/her upgrade. This information will be communicated with the venues/stadiums/arenas/teams box-office in real time.

By using the combination of the login info and the ticket info collected, the system 100 knows certain information about the user—i.e. face value of their tickets, if they are a season ticket holder with an account with the team and others. This information can be used to instantly help generate a value for the upgrade price, or the selection available to that individual for upgrades.

Next the system 100 may display the stadium map (Action Blocks 250, 255, 257, 259) or other alternative seat area selection process, such as tiles specifying a general area, and the user can choose available section that the user wants to upgrade to (Action Block 265). On selection of the available section the system 100 may offer all the vacant seats in the section and on selection of seat(s) the seat details will be pop up (Action Blocks 257, 259).

Once the system 100 receives the user's seat selection as the desired upgrade, the payment page (or screen) will appear. The payment page may appear on the same page as the seat details for the web application. The payment page may also appear on the separate page as the seat details in the native application. Payment may be collected by integrating an application program interface (“API”) for payments, e.g., through card.io, a credit card scanning system, or other third party technology (Action Blocks 270, 272).

After the system 100 receives payments, it sends an e-ticket to the user (Action Block 280) through the user's smartphone (via the application) and the ticket may have a moving animation, ticket details and other details to prevent unauthorized individuals from faking or take a screen shot of a ticket and try to pass it off as valid. The ticket may also have a watermark of the day that may change daily. The watermark can be the logo or mark of the team, venue, or the sold mark or logo of a sponsor or sold advertising. The backend administrative panel or the application's API will be able to send the watermark, and relevant moving animation and other relevant ticket information the day of the game; or all relevant information may be preprogrammed.

If the user purchases multiple tickets, the user may have the ability to send the tickets to his friends or others, or have the option to move down as a group. An exemplary method for sending out the tickets includes texting or emailing. A group ticket is send to a phone to allow the user to move to the upgrade together with his group. The group ticket will display the number of total tickets in the purchase. For example, if 4 tickets are purchased, the group ticket may have a large number 4 displayed proximately. If the user decides to send the tickets out, the sending option via text or other means will be limited to users that have established accounts with the application. The application may track and collect all the relevant information required, this may include, not but not limited to the user account, phone number or email, for sending out the tickets and to ensure there are no duplicate tickets.

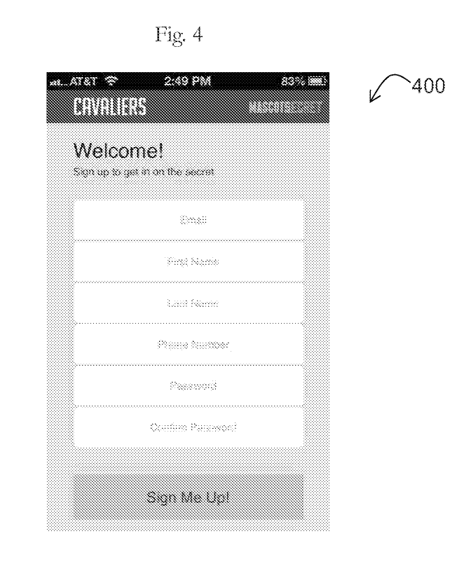

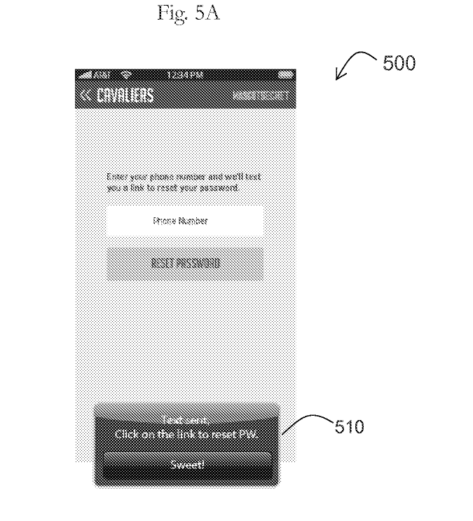

Turning to FIG. 3, according to an embodiment, an exemplary interface 300 shows a system's 100 main page. The appearance and organization of the user interface may change. For example, white label solutions may provide customizations for venues or teams (see, e.g., team's label in FIG. 4).

Turning to FIG. 4, according to an embodiment, an exemplary interface 400 shows a system's 100 sign up page. The signup Page may contain different fields for user to create account like email id, password, confirm password, first name, last name and phone number. On click of submit (SIGN ME UP!), a User Account may be created.

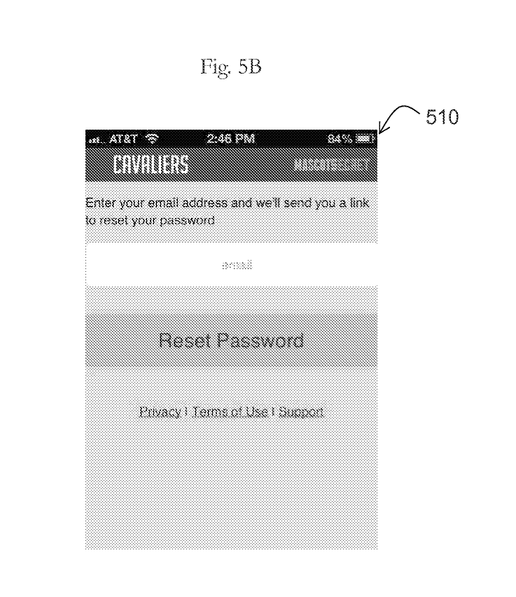

Turning to FIG. 5A, according to an embodiment, an exemplary interface 500 shows a system's 100 forget password page. After clicking on the forget password link in the sign-in page the user may be asked for a phone number to be texted a link to reset the password. After the phone number is inputted, a push notification 510 will pop up to give further instruction. Alternatively, as shown in FIG. 5B, according to an embodiment, an exemplary interface 510 shows another system's 100 forget password page. The user may be asked to the email associated with the account to be send a link to reset the password. After the email is inputted, a message notifying the user that a password reset link has been sent will appear to give further instruction.

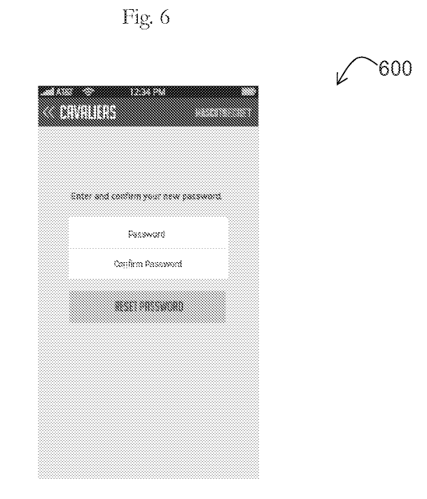

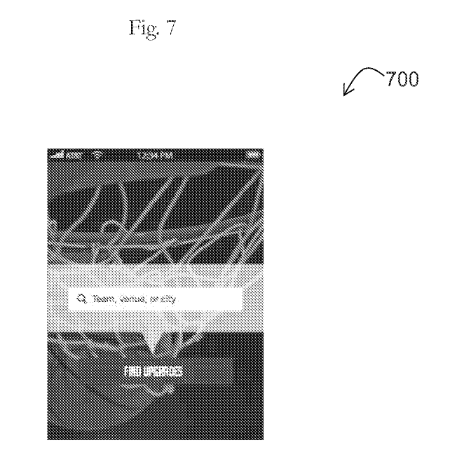

Turning to FIG. 6, according to an embodiment, an exemplary interface 600 shows a system's 100 enter new password page.

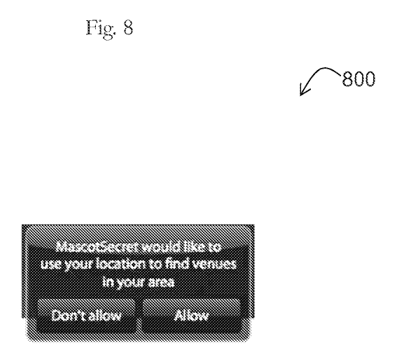

Turning to FIG. 7, according to an embodiment, an exemplary interface 700 shows a system's 100 venue search screen. After the user has logged in, the Venue Search Screen is displayed. The user can search based on events, team, venue or city and the list of events would be displayed on the screen. Turning to FIG. 8, according to an embodiment, an exemplary interface 800 shows a system's 100 venue search screen pop up notification.

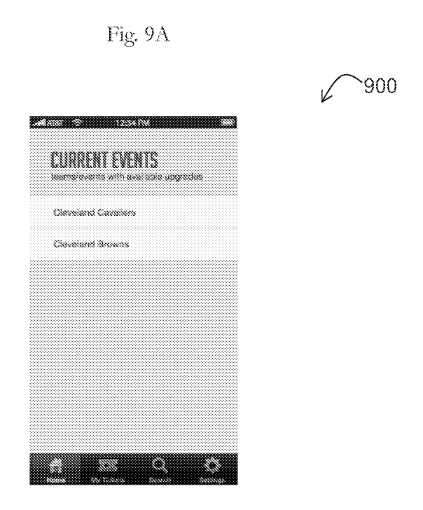

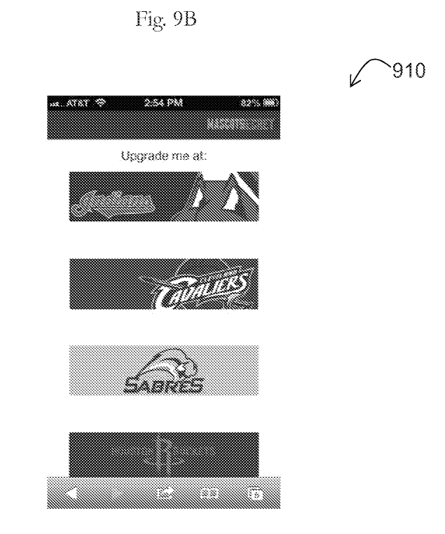

Turning to FIGS. 9A and 9B, according to an embodiment, exemplary interfaces 900 and 910 show a system's 100 alternative events list screens.

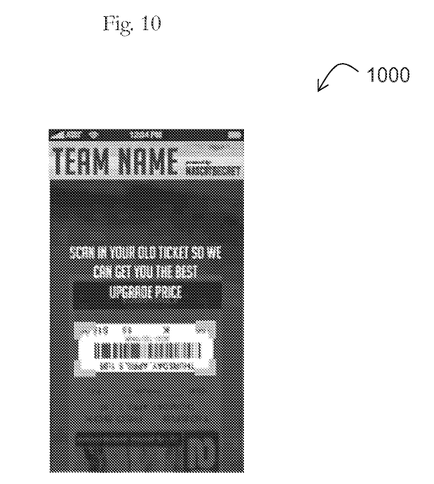

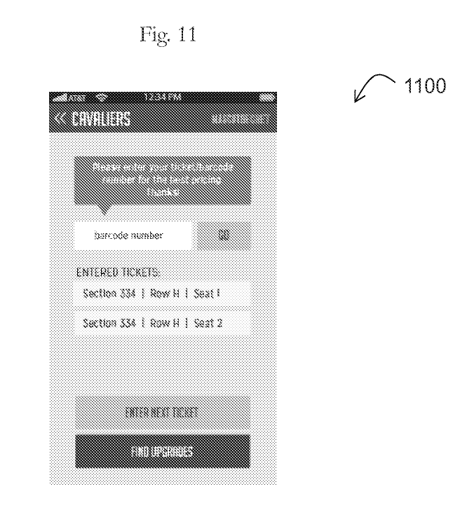

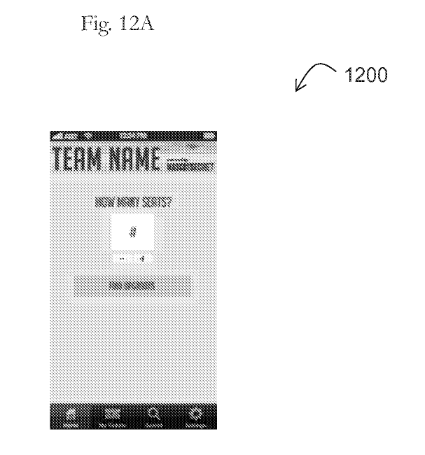

The system's 100 application and mobile browser may provide Seats for Upgrade screen. For native applications, the user may use the camera feature to scan in the original ticket. The user may use the exemplary interface 1000 shown in FIG. 10, which shows the system's 100 scan ticket screen. Alternatively, turning to FIG. 11, according to an embodiment, an exemplary interface 1100 shows a system's 100 enter ticket barcode screen where the user may enter the barcode of the user's ticket.

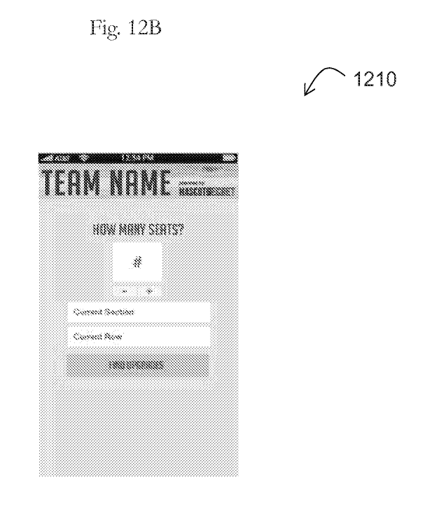

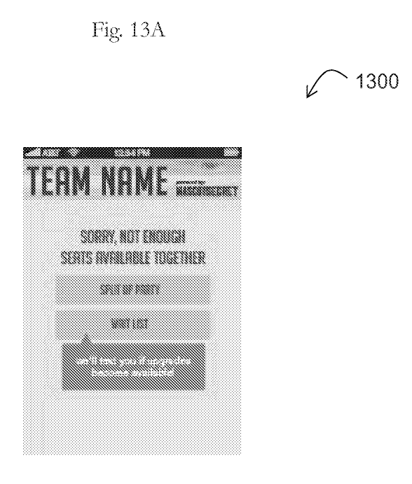

FIGS. 12A and 12B, according to an embodiment, show alternative exemplary interfaces 1200 and 1210 for web applications, where the user may enter how many seats he/she wants to upgrade. The user may also enter his/her present ticket location, i.e., Section and Row, original ticket's barcode and other necessary information.

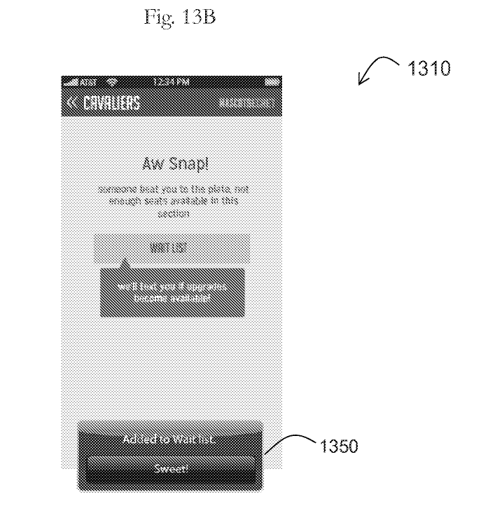

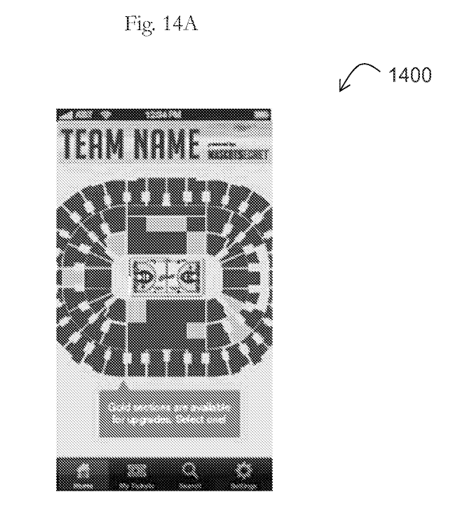

Turning to FIGS. 13A and 13B, according to an embodiment, exemplary interfaces 1300 and 1310 show a system's 100 seats not available screens. One of these screens may display when all seats are not available collectively. Then the user can have two options whether the user would like to Split Up or Wait for the seats to be available collectively. Seats maybe considered collective if they are not next to each other but within close proximity of each other. The application and mobile browser and its server will be able to determine the configuration of the available seats. When the clicks on waitlist button then Waitlist push notification 1350 would be displayed. The system's 100 administrative panel may already have the user's phone number since a phone number was requested when obtaining a user account.

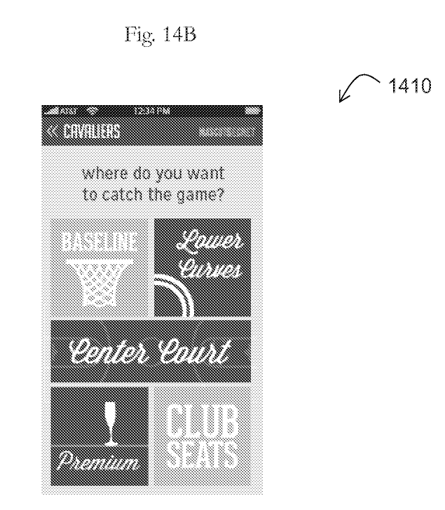

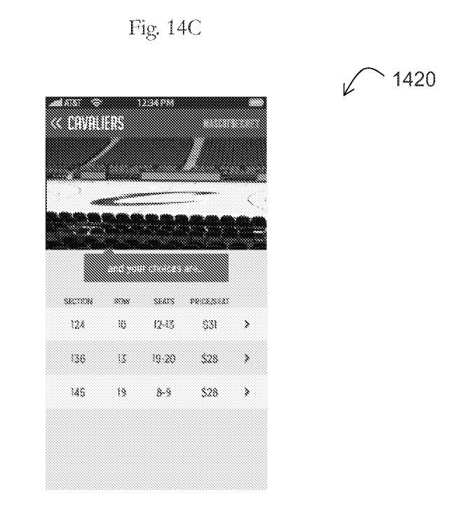

Available seats in the user's chosen section on stadium screen may be listed in the exemplary interfaces 1400 and 1410 and 1420 shown in FIG. 14A, 14B or 14C, detailing the system's 100 available seating screen, including prices.

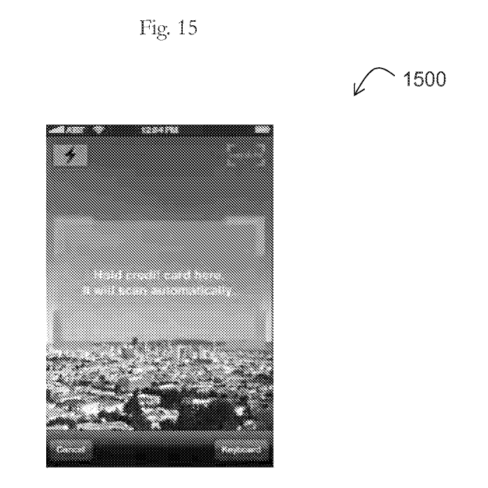

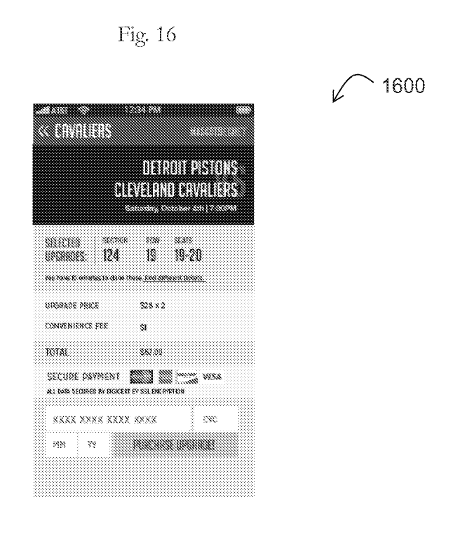

The application may provide a payment details screen. For a native application, the payment details screen may use an API or software, e.g., card.io technology or other third-party technology, to capture credit card information. An exemplary user interface 1500 for the native application's payment details screen is shown in FIG. 15. For a web application, clicking on the desired section for upgrade will show the seat details plus the payment details. The user may need to manually type in their payment information. In both the native application and the web application, the payment information may be shown along with the addition of a convenience charge, e.g., $1.00. An exemplary user interface 1600 for the web application is shown in FIG. 16 with a payment details screen.

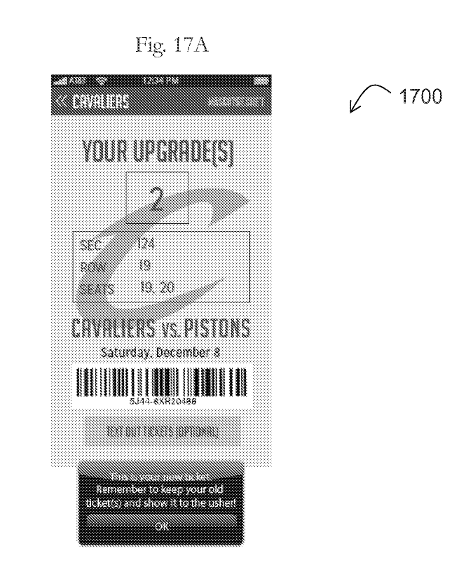

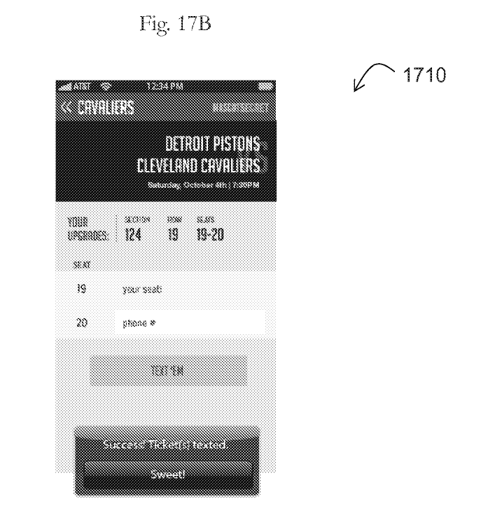

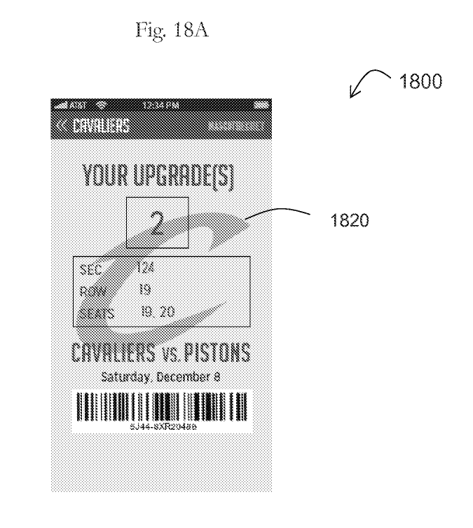

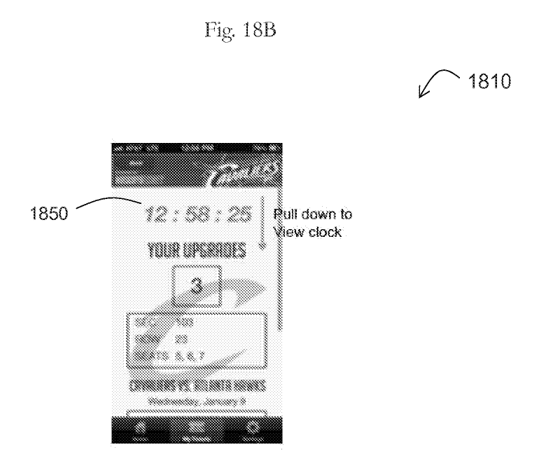

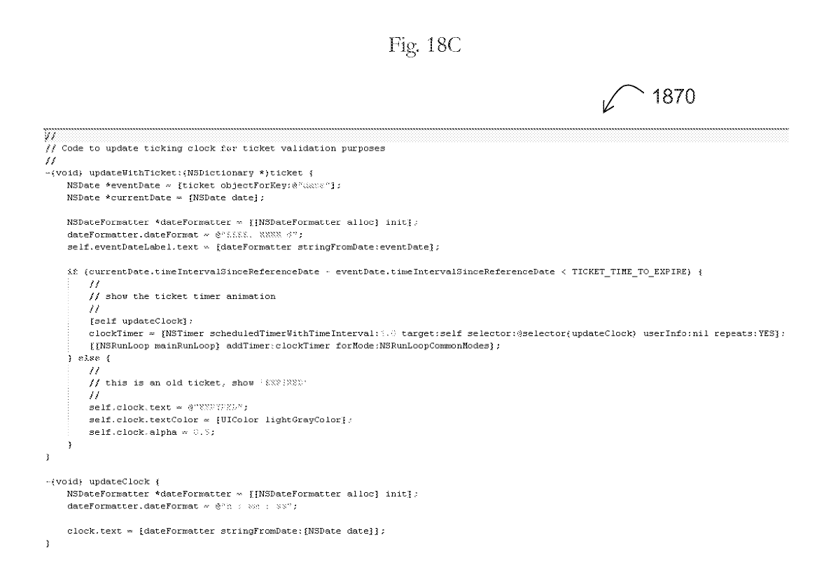

After the purchase of the upgrade, the system 100 sends to the user an electronic ticket confirming the purchase and the upgrade. FIG. 17A, according to an embodiment, shows an exemplary electronic ticket (or seat locator). During this time, the user may have the option of sending out (e.g., texting) tickets if more than one upgrade is purchased. FIG. 17B shows an exemplary screen after one or more tickets have been successfully sent (or texted). The user will not be required to send out the tickets. The user can alternatively move with his upgrade party as a group. FIG. 18A shows an exemplary electronic ticket without sending (texting) option, including watermark 1820. As described above, watermark 1820 can be changed with every game, and to allow teams to sell additional advertising.

Turning to FIG. 18B, according to an embodiment, the system 100 sends to the user an electronic ticket with a hidden clock 1850 for validation. The clock 1850 is generally hidden and the user has to pull down on the ticket to reveal it. The clock 1850 matches the time on the user's device when the ticket is valid. FIG. 18C shows an exemplary code 1870 for the clock 1850.

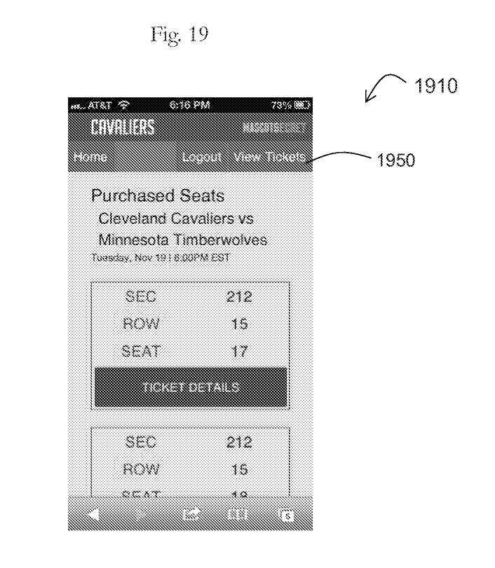

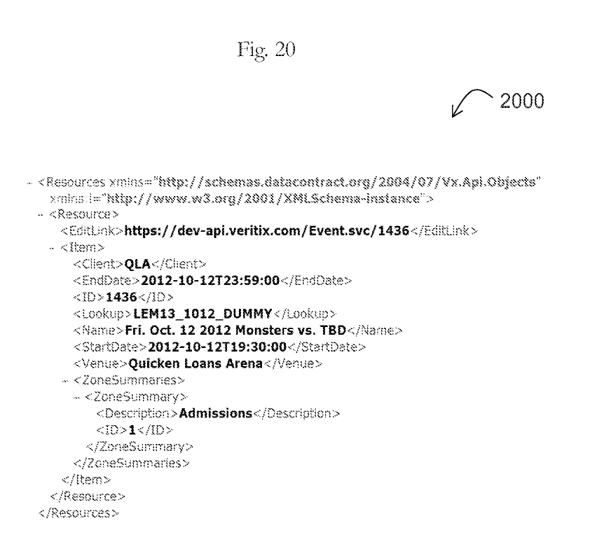

Turning to FIG. 19, according to an embodiment, the system 100 can allow users to check upgrade purchase history with View Tickets 1950. The View History will display in list view, or other similar arrangements, all the past upgrades purchased, with details of the upgrades such as section, row, seat for seat upgrades or the name, type, event of the experience purchased, and so on.

Third Party API. In an embodiment, the data for Venues, Tickets and Seating information may be provided by third-party's API. An example of communication with a third-party API is done by using a system 100's Window Communication Foundation (WCF) service. The system's 100 WCF service is a WCF Rest Service which calls third-party API and receives response in XML format. The XML response is then parsed and passed to mobile web application in JSON format. The service also stores data in the system' 100 backend administrative system/panel/dashboard.console or management tool or database for reporting purpose. The system 100 may use Entity Framework 4.1 for database interaction. The following provides an exemplary information about the third-party calls made and the response received.

Below is an exemplary method the application and the browser will create an user account:

SignUp:
Method Name: SaveUser( )
Description: Creates a new user for system 100 web application. The user is created in the system's 100 backend administrative system/panel/dashboard.console or management tool database and involves no call to third-party.
Third Party Request URL: N/A
Third Party Request Response: N/A

Below is an exemplary method of communication during SignIn:
SignIn:
Method Name: LoginUserQ
Description: Validate user credentials.
Third Party Request URL: The application may call on third-party API if relevant. For example, it may be relevant to cross check with client CRM immediately for user information if the application is embedded in with the client's own application.
Third Party Request Response:

Below is an exemplary method of communication during a search for the location of the venue
Search:
Method Name: EventSearchByVenue ( )
Description: Searches list of events on the basis of venuename and nexthours provided by user.
Third Party Request URL: https://dev-api.third/party.com/event.svc/search?nexthours={hours &venue={venuename}
Confidential—Design Document For MascotSecret 19
HTTP Method: GET
Parameter:
   Venuename: Venuename searched for.
   Nexthours: Mandatory field.

FIG. 20 is an exemplary XML code 2000 showing the system's 100 third-party request response.

Below is an exemplary method of communication during a search for the relevant Event in question.
Method Name: EventSearchByEventName ( )
Description: Searches list of events on the basis of eventname and nexthours provided by user.
Third Party Request URL: https://dev-api.thirdparty.com/event.svc/search?nexthours={hours}&eventname={eventname}
HTTP Method: GET
Parameter:
EventName: Event searched for.
Nexthours: Mandatory field.

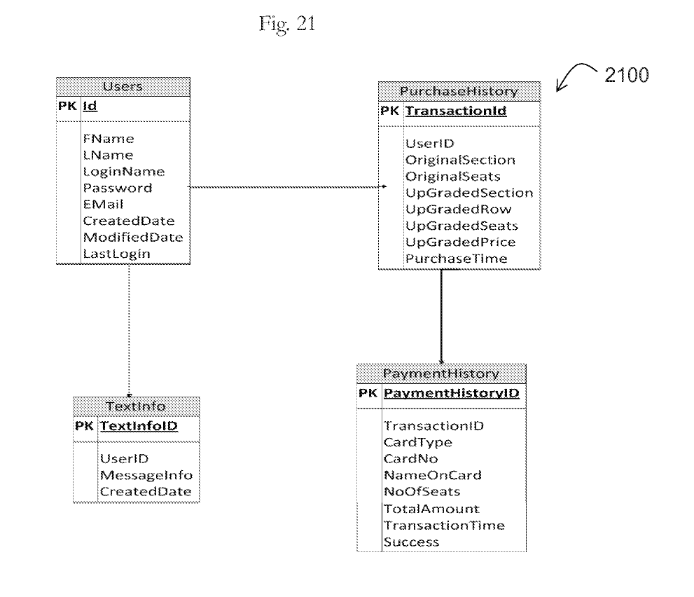

FIG. 21 is an exemplary entity relationship diagram 2100 showing the system's 100 entity relationships.

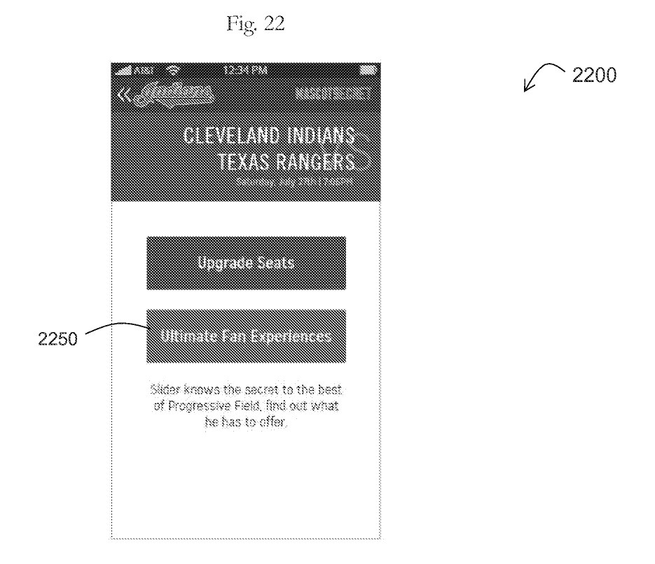

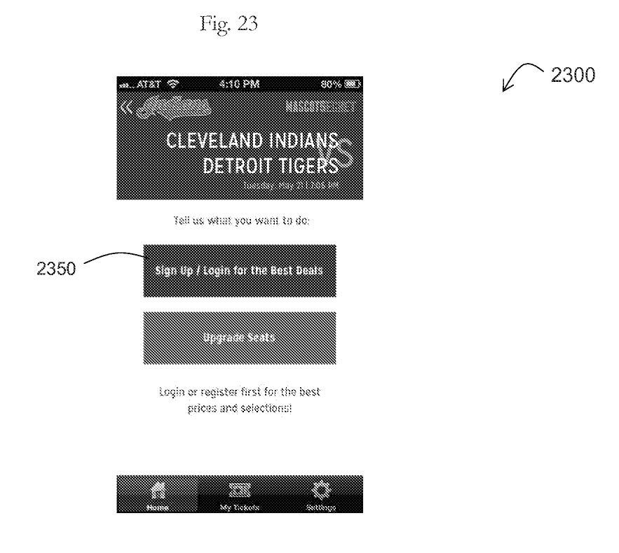

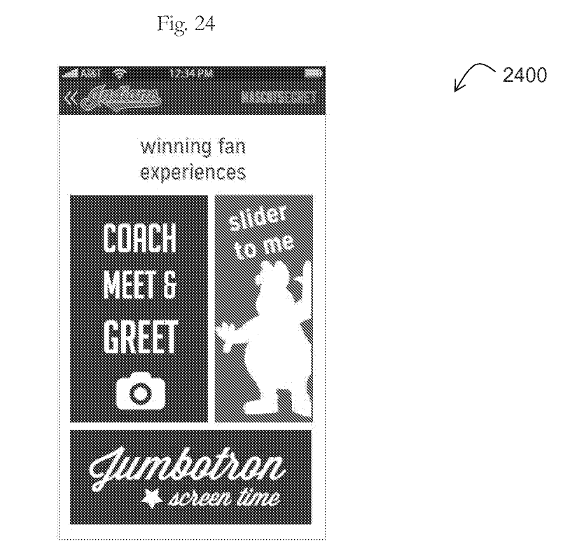

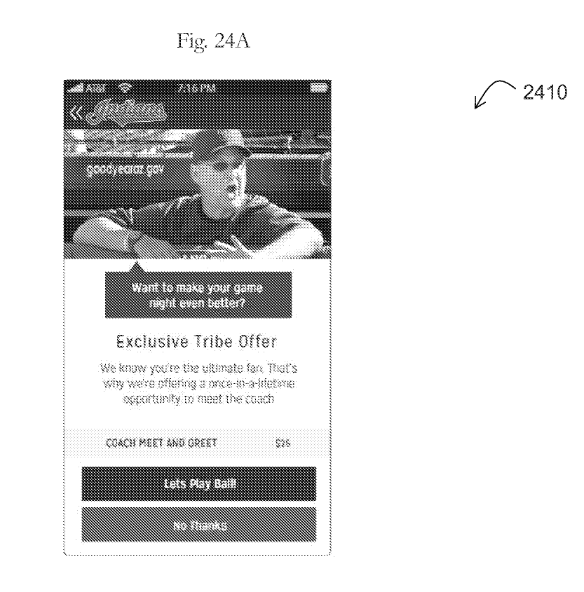

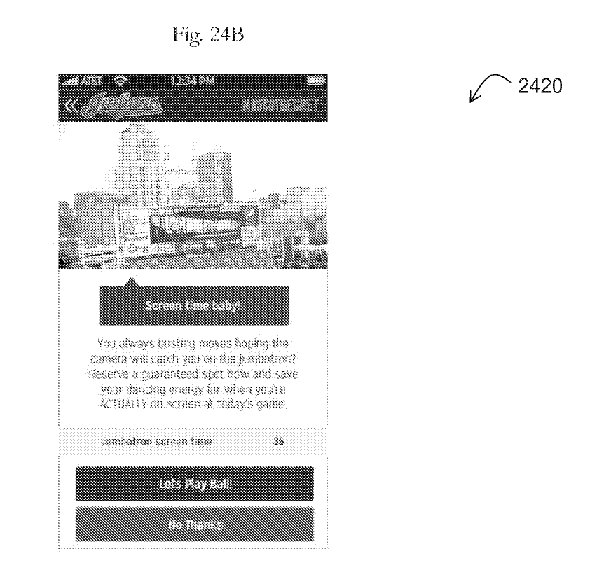

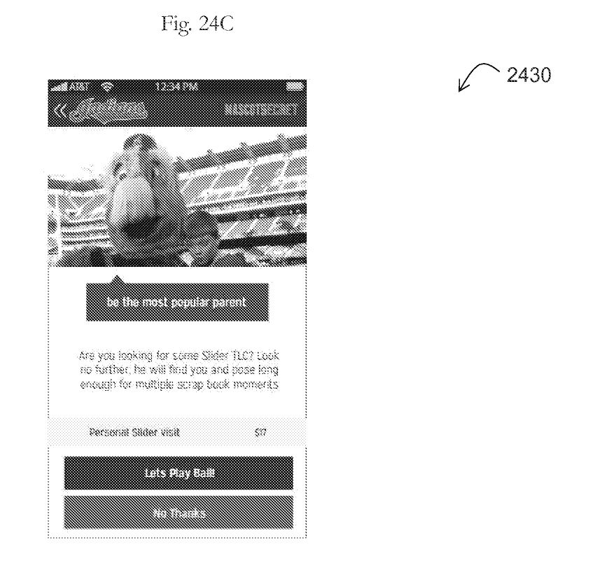

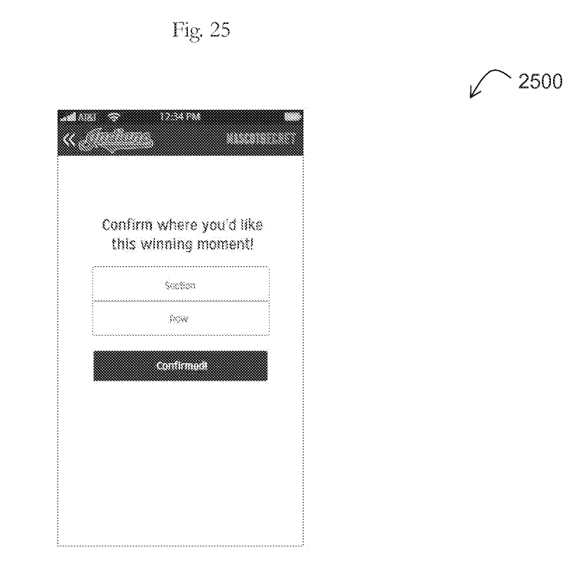

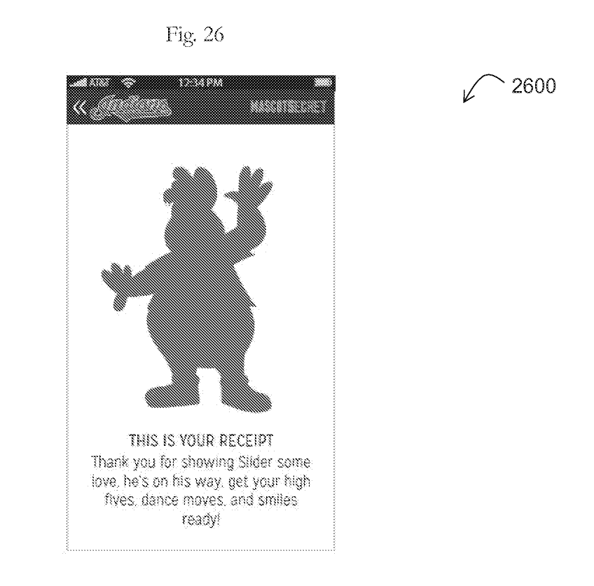

Turning to FIG. 22, according to an embodiment, an exemplary interface 2200 shows a system's 100 main page which includes a fan engagement (or fan experiences) application 2250 selection. Once the user selects the fan experiences 2250, the system 100 may ask the user to login to display the best deals 2350 selection, as shown in an exemplary interface in FIG. 23. Then system 100 may then display the exemplary interface 2400 as shown in FIG. 24. Interface 2400 displays one or more experiences (or services) available to the fans. These services include, but are not limited to, coach meet and greet, Jumbotron screen time, mascot meet, and so on. Once the fan selects a service, the system 100 displays the service screen with a price (FIGS. 24A, 24B, 24C). After the fan selects a service (e.g., click on “Let's Play Ball”), the system 100 displays interface 2500, as shown in FIG. 25, and asks the fan to confirm the purchase. The system 100 may ask the fan to enter the fan's location. The fan's location may also be captured through an application using the fan's device's camera that will read and process the information on the barcode on the fan's ticket. The system 100 may also know the fan's location using the login user account information, using geo-location, iBeacon, Bluetooth technology, or other location-based applications. The system 100 will display an electronic receipt 2600, as shown in FIG. 26, once the fan confirms the purchase.

In addition to the above described embodiments, those skilled in the art will appreciate that this disclosure has application in a variety of arts and situations and this disclosure is intended to include the same. The described embodiments also have applications in any system or venue that has inventory, including the traditional airline industry, especially with the new regulations where the airlines allow phones to be turned on during flights and with Wi-Fi capabilities on flights. The described embodiments also have applications in other systems, applications and venues including, but are not limited to, (1) in a restaurant, for example, a customer may want to talk to the chef, and the customer can orders the chef's time via his phone; (2) a restaurant customer is at the last seating and wants to use her phone to order a service to tour the kitchen; (3) a shopping customer in a shopping mall wants to purchase a car wash using his phone, providing the general location of the car and the car description; (4) a hotel customer on the way from airport and wants to use her phone to order a “relaxation package”, or a room service meals to her room so it can be ready at check-in.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media, remote or cloud-based storage media, and so on.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

It should be noted that while this particular representation of the disclosed subject matter portrays an application integrated into a platform's website or mobile application, the disclosed subject matter is not limited to such use and can also include other mediums, including but not limited to other parties' websites, television, mobile devices, and print.

Although example diagrams to implement elements of the disclosed subject matter have been provided, one skilled in the art, using this disclosure, could develop additional hardware, software, or processes to practice the disclosed subject matter and each is intended to be included herein.

What is claimed is:

1. A mobile upgrade and fan engagement system having one or more processors and a non-transitory computer-readable medium containing program instructions that cause said one or more processors to perform an electronic process for upgrading a seat or ticket holder at a stadium-based event, said process comprising:
receive login information from a mobile device of a seat or ticket holder;
retrieve account information based on the login information;
receive information of a first purchased ticket of the seat or ticket holder;
receive one or more upgrade selection requests from the mobile device;
determine availability of one or more upgrades to the seat or ticket holder;
display the availability of one or more upgrades at the mobile device;
receive one or more upgrade purchase requests based on availability, from the mobile device;
complete payment for the one or more upgrade purchases based on the one or more upgrade purchase requests;
display one or more upgrade electronic tickets, based on the complete payment for the one or more upgrade purchases, at the mobile device; and
release the first purchased ticket for sale.

2. A mobile upgrade and fan engagement system having one or more processors and a non-transitory computer-readable medium containing program instructions that cause said one or more processors to perform an electronic process for providing fan engagement to a seat or ticket holder at a stadium-based event, said process comprising:
receive login information from a mobile device of a seat or ticket holder;
retrieve account information based on the login information;
receive one or more fan engagement selection requests from the mobile device;
determine availability of one or more fan engagements to the seat or ticket holder;
display the availability of one or more fan engagements at the mobile device;
receive one or more fan engagement purchase requests based on availability, from the mobile device;
complete payment for the one or more fan engagement purchases based on the one or more fan engagement purchase requests; and
display one or more fan engagement receipts, based on the complete payment for the one or more fan engagement purchases, at the mobile device.
